(19) United States
(12) Patent Application Publication
(10) Pub. No.: US 2017/0214076 A1
(43) Pub. Date: Jul. 27, 2017

(54) MICROBIAL FUEL CELL LIGHT ASSEMBLY

(71) Applicant: Ankush Dhawan, Newburgh, IN (US)

(72) Inventor: Ankush Dhawan, Newburgh, IN (US)

(21) Appl. No.: 15/416,417

(22) Filed: Jan. 26, 2017

Related U.S. Application Data
(60) Provisional application No. 62/287,546, filed on Jan. 27, 2016.

(51) Int. Cl. H01M 8/16; H02J 7/00; F21V 23/02; H01M 16/00; H01G 11/08

(52) U.S. Cl. CPC H01M 8/16; H01M 16/003; H01G 11/08; F21V 23/02; H02J 7/0013; H01M 2250/30; F21Y 2115/10

(57) ABSTRACT

A microbial fuel cell light assembly, comprising a microbial fuel cell having a volume of sludge including soil and water, the sludge including electrogenic microbes, an anode disposed fully within the volume of sludge, a first lead connected to the anode, a cathode including a top surface and a bottom surface, the bottom surface of the cathode being disposed on a top surface of the volume of sludge and the top surface of the cathode being exposed to an external environment of the volume of sludge, a second lead connected to the cathode, at least one supercapacitor, and a light emitting diode powered by the at least one supercapacitor, wherein the supercapacitor receives a charge from the microbial fuel cell by way of connection with the first lead and the second lead prior to being electrically connected to the light emitting diode.

### CLAIM OF PRIORITY

This application claims priority to U.S. Provisional Patent Application No. 62/287,546, filed Jan. 27, 2016, the entire disclosure of which is incorporated by reference herein.

### FIELD OF THE INVENTION

The present disclosure relates generally to fuel cells and, more particularly, to improved microbial fuel cells and methods of use thereof.

### BACKGROUND

Of the approximately seven billion people in the world today, as many as 1.4 billion do not have access to electricity provided by an electrical power grid. Many of these people live in impoverished, remote locations that make reaching them with grid electricity both expensive and inefficient. Specifically, the cost of establishing the required infrastructure to provide grid electricity to sparsely populated locations is prohibitive. As such, many of these people rely on items such as kerosene fueled lamps, heaters, etc., that can be both dangerous and non-sustainable. For example, kerosene is a highly flammable fuel which can result in unexpected fires, fume buildup, etc. As well, the kerosene sources must be routinely resupplied which is inconvenient, and can lead to environmental issues as the delivery canisters may not be disposed of properly. In light of these issues, it is desirable to harness renewable energy from an inexpensive, accessible source that can be stored readily for future use as needed.

The present invention recognizes and addresses considerations of prior art constructions and methods.

### SUMMARY

One embodiment of a microbial fuel cell light assembly includes a microbial fuel cell having a volume of sludge including soil and water, the sludge including electrogenic microbes, an anode disposed fully within the volume of sludge, a first lead connected to the anode, a cathode including a top surface and a bottom surface, the bottom surface of the cathode being disposed on a top surface of the volume of sludge and the top surface of the cathode being exposed to an external environment of the volume of sludge, a second lead connected to the cathode, at least one supercapacitor; and a light emitting diode powered by the at least one supercapacitor, wherein the supercapacitor receives a charge from the microbial fuel cell by way of connection with the first lead and the second lead prior to being electrically connected to the light emitting diode.

Another embodiment includes a method of providing light in a domicile from microbial fuel cell light assembly including the steps of providing a domicile having a floor comprised of an earthen surface including soil, providing a microbial fuel cell including forming a volume of sludge including the soil of the earthen surface and water, the sludge including electrogenic microbes, disposing an anode fully within the volume of sludge, connecting a first lead to the anode, providing a cathode including a top surface and a bottom surface, disposing the bottom surface of the cathode on a top surface of the volume of sludge so that the top surface of the cathode is exposed to an external environment of the volume of sludge, connecting a second lead to the cathode, providing at least one supercapacitor and charging the at least one supercapacitor by connecting the first lead and the second lead thereto, and providing a light emitting diode and powering the light emitting diode by the at least one supercapacitor, wherein the topsoil of the sludge is contiguous to an earthen surface.

Yet another embodiment of the present application is a method of providing a source of light, including providing a microbial fuel cell by providing a volume of sludge by mixing soil and water, the sludge including electrogenic microbes, providing an anode including a first lead connected to the anode, disposing the anode fully within the volume of sludge, providing a cathode including a top surface, a bottom surface, and a second lead connected to the cathode, placing the bottom surface of the cathode on a top surface of the volume of sludge so that the top surface of the cathode is exposed to an external environment of the volume of sludge, providing at least one supercapacitor, connecting the at least one supercapacitor to the first and second leads of he microbial fuel cell so that the at least one supercapacitor receives a charge, providing a light emitting diode, disconnecting the at least one supercapacitor for the microbial fuel cell, and connecting the at least one supercapacitor to the light emitting diode so that the at least one supercapacitor provides power for the light emitting diode.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawing, in which:

FIG. 1 is a schematic diagram of a microbial fuel cell and super capacitor in accordance with an embodiment of the present disclosure;

FIG. 2 is an electrical diagram of a microbial fuel cell light assembly in accordance with the present disclosure;

FIG. 3 is a schematical representation of microbial fuel cells, in accordance with the present disclosure, formed directly in an earthen surface;

FIGS. 4A and 4B are graphical representations of charging operations for super capacitors, utilizing the microbial fuel cell shown in FIG. 1;

FIG. 5 is a graphical representation of maximum voltages generated by microbial fuel cells, as shown in FIG. 1, over a series of individual tests; and

FIG. 6 is a table showing the organic content of various soil types for producing sludge used in the microbial fuel cell shown in FIG. 1.

Repeat use of reference characters in the present specification and drawing is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

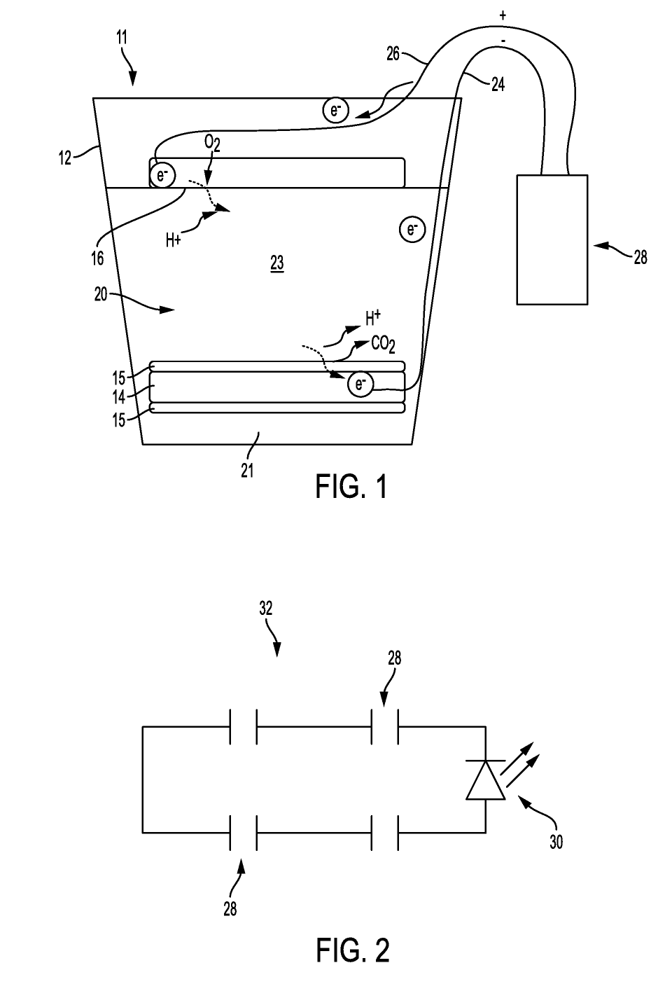

Referring now to FIGS. 1 and 2, an embodiment of a microbial fuel cell light assembly includes a microbial fuel cell 11, at least one supercapacitor 28, and a light emitting diode 30. As shown, microbial fuel cell 11 includes an open-top container 12, a volume of sludge 20 disposed therein that is formed by mixing soil and water, an anode 14 disposed fully within sludge 20, and a cathode 16 disposed on a top surface of the sludge. A first lead 24 and a second lead 26 are connected to anode 14 and cathode 16, respectively, and allow supercapacitor 28 to be electrically connected to microbial fuel cell 11 for charging, as discussed in greater detail below.

Referring specifically to FIG. 1, microbial fuel cell 11 provides a renewable energy source in which organic matter present in the sludge is converted to electricity utilizing electrogenic microbes that are also present in the sludge. When the electrogenic microbes 15 are present in the oxygen-free chamber of the fuel cell, i.e. disposed in the sludge, they attach to anode 14 that is disposed therein. As the electrogenic microbes consume food present in the sludge under anaerobic conditions, they produce carbon dioxide, protons and electrons. These free electrons migrate to anode 14. As noted, cathode 16 is exposed to oxygen of the surrounding environment. At cathode 16, the electrons, oxygen and protons combine to form water. The transfer of electrons from anode 14 to cathode 16 generates electricity. As shown in FIG. 1, it is this electricity that is used to charge supercapacitor 28 that is connected to anode 14 and cathode 16 by first lead 24 and second lead 26, respectively. After one or more supercapacitors 28 are charged by the microbial fuel cell 11, they are connected in series with light emitting diode 30 to provide a source of electricity, as shown in FIG. 2.

A method of forming a microbial fuel cell light assembly 10 in accordance with the present invention is now discussed. Referring first to FIG. 1, to create microbial fuel cell 11, sludge 20 is formed by mixing soil with water. Preferably, topsoil is used when mixing the sludge, although in alternate embodiments soil such as humus mixed with manure may be used. Next, a bottom layer 21 of sludge 20 is placed in the bottom of container 12. Bottom layer 21 is approximately one centimeter in height. Anode 14 is placed on top of bottom layer 21 prior to placing a top layer 23 of sludge 20 on top of the anode. Top layer 23 of sludge 20 is approximately four centimeters in height. Next, cathode 16, which is formed from the same material as anode 14, is placed on a top surface of the sludge disposed within container 12. First lead 24 and second lead 26 are attached to anode 14 and cathode 26, respectively, to facilitate completing an electrical circuit with a corresponding supercapacitor 28. Note, first lead 24 is connected to anode 14 prior to disposing the anode in container 12. In the preferred embodiment shown, both anode 14 and cathode 16 are constructed from graphite. Note, however, in alternate embodiments both anode and cathode may be constructed of copper, steel mesh, aluminum, etc. As well, in alternate embodiments, a container is not used. Rather, anode 14 can be buried in sludge 20 that is formed by mixing water with an earthen surface (“the ground”). Supercapacitor 28 preferably includes a rated capacitance of at least 10 Farads. Tests were also conducted utilizing supercapacitors rated as high as 50 Farads.

As noted above, a container is not required for forming each embodiment of the disclosed microbial fuel cell. This can be particularly advantageous in very remote locations where a domicile, such as, but not limited to, lean-tos, earthen huts, shanties, tents, etc., may be constructed with an earthen floor 42. Although microbial fuel cells 11 may be constructed as described above in these locations, they may also be formed by creating an area of sludge 20 directly on the earthen floor and burying anode 14 in that area. A cathode 16 is then placed above anode 14 on that portion of the earthen floor. Multiple microbial fuel cells 11 can be formed in this manner for charging multiple supercapacitors 28. With this approach, a bank of charged supercapacitors 28 can be maintained that helps insure at least a few hours of light from a LED can be utilized as the supercapacitors 28 are rotated on a daily basis (as needed).

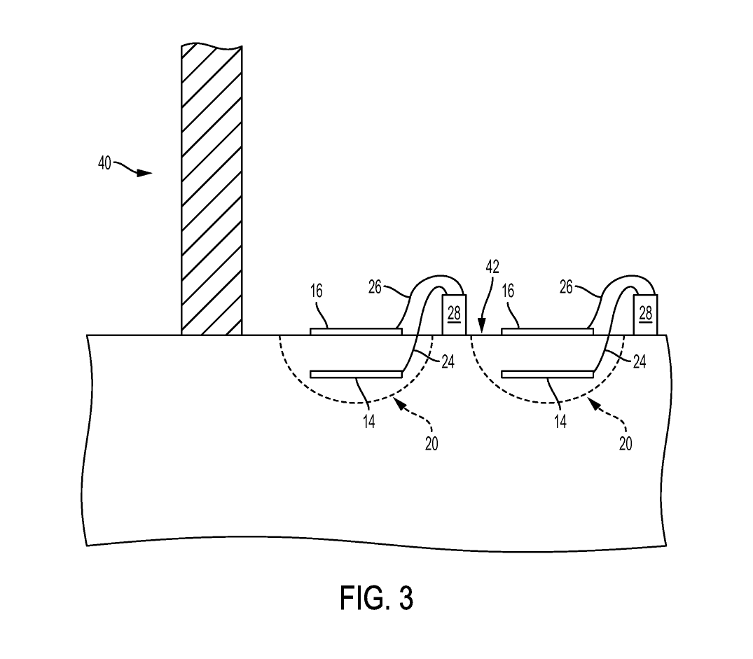

Referring now to FIGS. 3A and 3B, two independent charging operations of supercapacitors 28 utilizing microbial fuel cells 11 as described above are shown. The results for both operations are similar in that after a period of approximately 100 hours, each microbial fuel cell 11 was able to produce a voltage of approximately 400 to 500 millivolts (mV). The voltage produced by each microbial fuel cell 11 in the graphs is represented by line 25. Note, in both charging operations, each microbial fuel cell 11 was able to maintain the approximate voltage of 500 mV over a 300 hour period. As such, each microbial fuel cell 11 is capable of charging a plurality of supercapacitors 28, in the instant case three supercapacitors. As reflected in both graphs of the charging operations, the described microbial fuel cells 11 are capable of charging each of the supercapacitors to a final charge of approximately 500 mV.

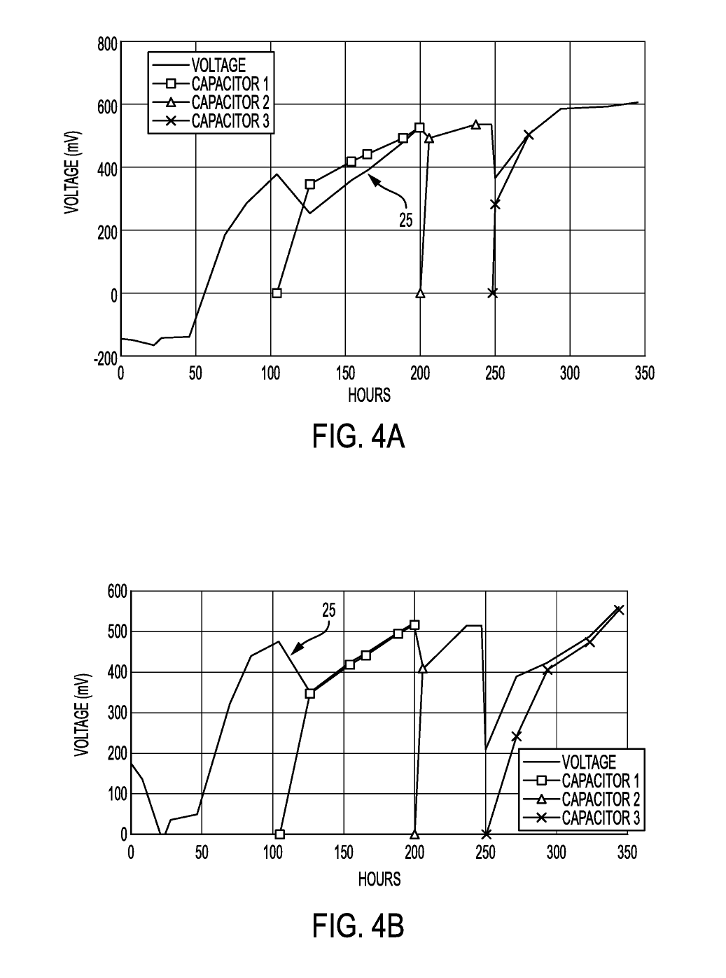

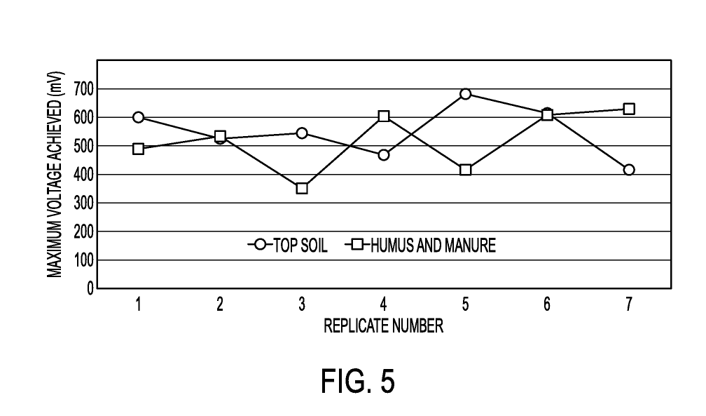

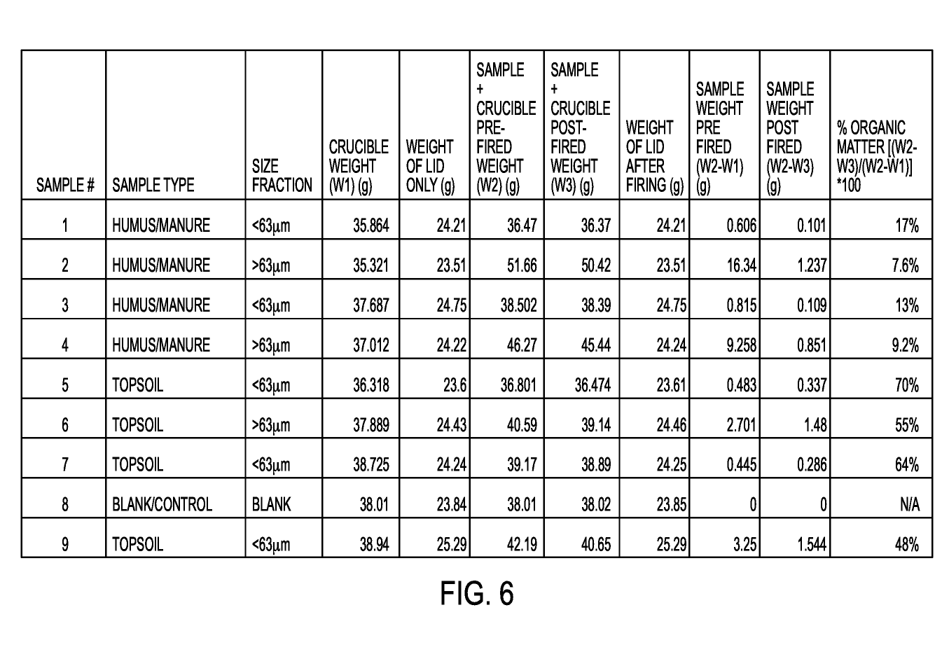

Referring now to FIG. 4, tests were conducted on two sets of microbial fuel cells 11, as described above, one set utilizing topsoil to form sludge and the other set utilizing a humus/manure mixture for the sludge. Over the range of tests, the microbial fuel cells utilizing topsoil were found to perform slightly better with regard to producing a constant maximum voltage, although the humus/manure fuel cells did achieve a higher maximum voltage in two of the test runs. Referring additionally to FIG. 5, a series of ash tests were run on both the humus/manure and topsoil samples to determine what contributed to a more consistent voltage of the topsoil samples. As reflected in the table, the topsoil sludge samples have organic content in the range of 48 to 70 percent, whereas the highest organic content found humus/manure samples was 17 percent. As would be expected, the higher organic content of the topsoil samples provides more fuel for the electrogenic microbes present in the sludge, which leads to more consistent production of voltages.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

What is claimed:

1. A microbial fuel cell light assembly, comprising:
a microbial fuel cell comprising:
a volume of sludge including soil and water, the sludge including electrogenic microbes;
an anode disposed fully within the volume of sludge;
a first lead connected to the anode;
a cathode including a top surface and a bottom surface, the bottom surface of the cathode being disposed on a top surface of the volume of sludge and the top surface of the cathode being exposed to an external environment of the volume of sludge;
a second lead connected to the cathode;
at least one supercapacitor; and
a light emitting diode powered by the at least one supercapacitor,
wherein the supercapacitor receives a charge from the microbial fuel cell by way of connection with the first lead and the second lead prior to being electrically connected to the light emitting diode.

2. The microbial fuel cell light assembly of claim 1, wherein the at least one supercapacitor further comprises a plurality of supercapacitors connected in series with the light emitting diode.

3. The microbial fuel cell light assembly of claim 2, wherein the plurality of supercapacitors comprises four supercapacitors.

4. The microbial fuel cell light assembly of claim 2, wherein each supercapacitor of the plurality of supercapacitors has a capacitor rating of at least 10 Farads.

5. The microbial fuel cell light assembly of claim 1, wherein the soil comprises topsoil indigenous to a geographic location of which the microbial fuel cell is disposed.

6. The microbial fuel cell light assembly of claim 5, further comprising an open top container in which the volume of sludge is disposed.

7. The microbial fuel cell light assembly of claim 5, wherein the anode is disposed directly into topsoil that is contiguous to a surface of Earth.

8. The microbial fuel cell light assembly of claim 1, wherein the anode and cathode are both one of graphite, copper, aluminum and steel mesh.

9. A method of providing light in a domicile from microbial fuel cell light assembly, comprising the steps of:
providing a domicile having a floor comprised of an earthen surface including soil;
providing a microbial fuel cell including:
forming a volume of sludge including the soil of the earthen surface and water, the sludge including electrogenic microbes;
disposing an anode fully within the volume of sludge;
connecting a first lead to the anode;
providing a cathode including a top surface and a bottom surface;
disposing the bottom surface of the cathode on a top surface of the volume of sludge so that the top surface of the cathode is exposed to an external environment of the volume of sludge;
connecting a second lead to the cathode;
providing at least one supercapacitor and charging the at least one supercapacitor by connecting the first lead and the second lead thereto; and
providing a light emitting diode and powering the light emitting diode by the at least one supercapacitor,
wherein the topsoil of the sludge is contiguous to an earthen surface.

10. The method of claim 9, wherein the step of charging at least one supercapacitor further comprises charging a plurality of supercapacitors, and the step powering the light emitting diode further comprises connecting the plurality of supercapacitors in series with the light emitting diode.

11. The method of claim 10, wherein the plurality of supercapacitors comprises four supercapacitors.

12. The method of claim 10, wherein each supercapacitor of the plurality of supercapacitors has a capacitor rating of at least 10 Farads.

13. A method of providing a light source, comprising the steps of:
providing a microbial fuel cell by:
providing a volume of sludge by mixing soil and water, the sludge including electrogenic microbes;
providing an anode including a first lead connected to the anode;
disposing the anode fully within the volume of sludge;
providing a cathode including a top surface, a bottom surface, and a second lead connected to the cathode;
placing the bottom surface of the cathode on a top surface of the volume of sludge so that the top surface of the cathode is exposed to an external environment of the volume of sludge;
providing at least one supercapacitor;
connecting the at least one supercapacitor to the first and second leads of he microbial fuel cell so that the at least one supercapacitor receives a charge;
providing a light emitting diode;
disconnecting the at least one supercapacitor for the microbial fuel cell; and
connecting the at least one supercapacitor to the light emitting diode so that the at least one supercapacitor provides power for the light emitting diode.

14. The method of claim 13, wherein the step of connecting the at least one supercapacitor to the light emitting diode further comprises connecting a plurality of supercapacitors in series with the light emitting diode.

15. The method of claim 14, wherein each supercapacitor of the plurality of supercapacitors has a capacitor rating of at least 10 Farads.

16. The method of claim 13, wherein the soil used to mix the sludge comprises topsoil indigenous to a geographic location of which the microbial fuel cell is disposed.

17. The method of claim 16, wherein disposing the anode fully within the volume of sludge further comprises burying the anode within the volume of sludge that is contiguous to a surface of Earth.
